(19) United States
(12) Patent Application Publication
(10) Pub. No.: US 2019/0289868 A1
(43) Pub. Date: Sep. 26, 2019

(54) MILK PROTEIN CONCENTRATES WITH A REDUCED ASH CONTENT

(71) Applicant: DMK Deutsches Milchkontor GmbH, Zeven (DE)

(72) Inventor: Sven-Rainer DÖRING, Zeven (DE)

(21) Appl. No.: 16/359,246

(22) Filed: Mar. 20, 2019

(30) Foreign Application Priority Data
Mar. 21, 2018 (EP) 18 163 033.6

(51) Int. Cl. A23C 9/15; A23C 9/16; A23C 9/142

(52) U.S. Cl. CPC A23C 9/1512; A23C 2210/206; A23C 9/1422; A23C 9/16

(57) ABSTRACT

A milk protein concentrate is suggested, obtainable or obtained by:
(i) skimming the cream from raw milk, obtaining a skimmed milk fraction having a dry matter content of about 5 to about 15% by weight, and particularly about 10% by weight;
(ii) concentrating the skimmed milk fraction of step (i) to a dry matter content of about 45 to about 60% by weight;
(iii) standardising the skimmed milk concentrate of step (ii) by adding a milk fraction; and
(iv) drying the standardised skimmed milk concentrate to a powder having a dry matter content of at least 95% by weight,
   with the proviso that a milk permeate is employed for standardisation, which was previously subjected to electrodialysis.

### FIELD OF THE INVENTION

The invention is in the field of dairy products and relates to novel protein concentrates, characterised by both a defined lactose content and a reduced ash content, a process for their production, and their use.

### STATE OF THE ART

Typically, the production of milk protein concentrates is performed on the basis of skimmed milk which is dehydrated in several steps, preferably in two steps, to a dry matter content of about 50% by weight, before the concentrate is typically placed into a spray tower. To this end, evaporators applying mechanical or thermal vapour compression-evaporation are conventionally employed. Recently, RO membrane systems have been used to some extent for pre-concentration, thus achieving dry matter contents of up to 36%.

However, the concentrate intermediately produced during further dehydration has a protein content which is too high and must therefore be adjusted, i.e., “standardised” by adding lactose or lactose-containing milk fractions. The rationale here is a substantial difference between the North and the South of Europe. Skimmed milk powder from the North typically has a protein content of up to 38% in dry matter while such powders from the South of Europe only contain about 33% by weight protein in dry matter. In order to avoid competitive distortions, the protein content in such milk powders was set to 34% by weight in the non-fat dry matter by resolution, which, however, means that within the EC a product of a lower protein content is not to be referred to as a skimmed milk powder, but may only be referred to as a dairy product.

For standardisation, it is recommended to add to the concentrate the required amount of lactose itself. This may be the easiest way and may also be advantageous, as the ash input of about 7% by weight is thus sensorily acceptable, based on the eventually produced protein concentrate, which would otherwise have a detrimental effect on the taste of the milk. It is, however, a disadvantage that this variant is the most expensive variant at the same time, because the lactose needs to be dried in a complex process first, before it can be dissolved and dried again.

Dairy technology, instead, uses a lactose-containing dairy stream, i.e., a so-called milk permeate. Standardisation may be easily achieved also in this manner, as the permeate exists in liquid form and may be easily fed in. Here, it is advantageous that milk permeates are otherwise of little commercial use and are significantly less expensive than the valuable lactose, which is useful with respect to process economics. It is, however, disadvantageous that the ash input is significantly higher (at least 8% by weight in the protein concentrate), which has a considerably stronger adverse effect on the taste of the milk powder.

### Relevant State of the Art

Milk powders with a high whey protein index, for example, are known from EP 2732706 B1 (DMK) and are obtained by (a) removing solids from the raw milk in a manner known in itself, separating the cream, (b) subjecting the skimmed milk such obtained to steam infusion, (c) concentrating the heated milk to a dry matter content of 30 to 50% by weight, (d) optionally, subjecting the concentrate such obtained to heat treatment at a minimum of 72° C. for a period of at least 15 seconds, and (e) processing the heat-treated product such obtained into a dry powder.

In this context, it is also referred to EP 3103350 A1 (DMK), disclosing a process for the production of whey protein concentrates, comprising the following steps: (a) ultrafiltration of whey at a temperature of about 2 to about 25° C. for the production of a first retentate R1 and a first permeate P1; (b) microfiltration of the retentate R1 of step (a) at a temperature of about 2 to about 35° C. for the production of a second retentate R2 and a second permeate P2; (c) ultra-filtration of the second permeate P2 of step (b) at a temperature of about 6 to about 25° C. for the production of a third retentate R3 and a third permeate P3; (d) pasteurisation of the retentate R3 of step (c), and (e) drying of the pasteurised product of step (d).

EP 3221554 A1 (DMK) discloses a demineralised high-protein whey powder which is obtainable by: (a) separating raw milk, skimming the cream; (b) subjecting the skimmed milk such obtained to microfiltration or micro-diafiltration, thus obtaining a permeate P1 that is rich in whey protein and contains a retentate R1, containing casein and GMP; (c) subjecting the permeate P1 to a separation by means of column chromatography where the lactoferrin contained therein remains on the column; (d) subjecting the permeate whose lactoferrin was separated in this manner to dialysis; and (e) dehydrating the diluate such obtained.

However, none of the documents cited relates to the production of milk protein concentrates of the type mentioned.

The object of the present invention was, therefore, to provide milk protein concentrates in powder form, preferably on the basis of skimmed milk, having a protein content of at least 34% by weight and a lactose content of 45 to 60% by weight, while the ash content is at a maximum of 7.5% by weight.

### DESCRIPTION OF THE INVENTION

A first subject matter of the invention relates to a milk protein concentrate, obtainable or obtained by:
(i) skimming the cream from raw milk, obtaining a skimmed milk fraction having a dry matter content of about 5 to about 15% by weight, and particularly about 10% by weight;
(ii) concentrating the skimmed milk fraction of step (i) to a dry matter content of about 45 to about 60% by weight;
(iii) standardising the skimmed milk concentrate of step (ii) by adding a milk fraction; and
(iv) drying the standardised skimmed milk concentrate to a powder having a dry matter content of at least 95% by weight,
   with the proviso that a milk permeate is used for standardisation, which was previously subjected to electrodialysis.

A further subject matter of the invention relates to a process for the production of skimmed milk protein concentrates, comprising or consisting of the following steps:
(i) providing a skimmed milk with a dry matter content of about 5 to about 15% by weight, and particularly about 10% by weight;
(ii) concentrating the skimmed milk of step (a) to a dry matter content of about 45 to about 60% by weight;
(iii) standardising the skimmed milk concentrate of step (ii) using a milk fraction; and
(iv) drying the standardised skimmed milk concentrate of step (iii), obtaining a skimmed milk protein concentrate with a dry matter content of at least 95% by weight,
   which is characterised in that a milk permeate is used for standardisation, which was previously subjected to electrodialysis.

Surprisingly, it was found that, by means of these measures, a protein concentrate was obtained that fully complies with the above described requirements, i.e., having a protein content of at least 34% by weight and a lactose content of about 45 to about 60% by weight and an ash content of a maximum of 7.5, preferably about 6.5 to about 7.2% by weight in the non-fat dry matter.

### PROCESS OF PRODUCTION

The process of the invention may be based on both raw milk and skimmed milk as, in any case, the first process step consists of providing skimmed milk having a dry matter content within the range of about 5 to 15% by weight, and particularly of 9 to 10% by weight. This is typically a standard skimmed milk, obtained after skimming the cream from the raw milk in the separator, and typically having a dry matter content of about 30% by weight.

### Concentration

In a conventional evaporator, a further portion of water is subsequently removed from the skimmed milk such obtained, obtaining a concentrate with a dry matter content within the range of about 45 to about 60% by weight, and typically about 50% by weight.

### Standardisation

As mentioned above, the skimmed milk concentrate such obtained has an ash content that is too high for the subsequent application that specifically concerns milk powders for toddlers, so that a standardisation step is becoming necessary at this point. To this end, a lactose-containing dairy stream, i.e., a milk permeate is added to the concentrate. This is preferably a milk permeate, obtained by ultrafiltration of milk, i.e., raw milk, whole milk or skimmed milk.

Standardisation, i.e., the addition of the diluate may be performed at different steps of the process, for example, it may be blended with the milk before or after it is heated, i.e., before the separation step. It is also possible to add the diluate before pasteurisation or during any of the concentration steps.

### Ultrafiltration

Ultrafiltration is a filtration process from the field of membrane technology, by means of which macro-molecular substances and small particles may be separated from a medium and concentrated. The degree of separation is decisive for the difference between macrofiltration, ultrafiltration and nanofiltration. If the cut-off limit (or also “cut-off”) is 100 nm or more, it is referred to microfiltration. If the cut-off limit is in the range between 2-100 nm, this is referred to as ultrafiltration. In the case of nanofiltration, the cut-off limit is below 2 nm. In each of these cases, this concerns purely physical, i.e., mechanical membrane separation methods which apply the principle of mechanical size exclusion: all particles in the fluids which are larger than the membrane pores are retained by the membrane. The driving force in both separation methods is the differential pressure between the inlet and the outlet of the filter area, which is between 0.1 and 10 bar.

The cut-off limits of nanofiltration membranes are also indicated in form of the NMWC (Nominal Molecular Weight Cut-Off, also referred to as MWCO, Molecular Weight Cut Off, unit: Dalton). It is defined as the minimal molecular mass of more global molecules, 90% of which are retained by the membrane. In practice, the NMWC should be at least 20% lower than the molecular mass of the molecule to be separated. Further qualitative statements on filtration may be made by means of the flux (water value) (transmembrane flux or passage rate). Ideally, it is proportional to the transmembrane pressure and reciprocal to the membrane resistance. These sizes are determined both by the characteristics of the membrane used and by concentration polarisation and possibly occurring fouling. The passage rate relates to 1 m² of membrane area. Its unit is l/(m²h bar).

Membranes having a pore size within the range of about 1,000 to about 50,000, and preferably about 5,000 to about 25,000 Dalton have proven to be particularly suitable for ultrafiltration. Under these conditions, both lactose and ash as well as mineral substances pass the membrane in the ultrafiltration step and accumulate in the permeate.

The material of the filtration area—both in ultrafiltration and in nanofiltration—may represent stainless steel, polymer materials, ceramics, aluminium oxide or textile fabric. Filter elements appear in different forms: candle filters, flat membranes, spiral coil membranes, bag filters and hollow fibre modules, all of which are, in principle, suitable within the meaning of the present invention. However, spiral coil membranes made of polymer materials or candle filters made of ceramics or aluminium oxide are preferably used, where the first form of embodiment has proved to be particularly preferred for ultrafiltration, and the second one for nanofiltration.

Ultrafiltration within the meaning of the present invention may be performed “hot” or “cold”, i.e., within the temperature range of about 10 to about 60° C. However, it is preferred to operate at temperatures in the lower range from 10 to about 20° C.

### Electrodialysis

The permeate from the ultrafiltration step of the raw milk is rich in lactose, but it does also contain a high amount of ash, i.e., mineral components which, eventually, give the resulting milk powder a bitter taste. It has now been proven that electrodialysis is a simple and inexpensive method to deplete the ash content in the permeate such that only values of a maximum of 7.5% by weight, and particularly 6.5 to 7.2% by weight were achieved in the final product, which no longer leads to any perceivable bitter taste.

Electrodialysis is an electro-chemically driven membrane process in which ion exchanger membranes are used in combination with an electric potential difference to separate ionic species from uncharged solvents or from contaminations.

To this end, the space between two electrodes in an electrodialysis separator is separated by a stack of alternating anion and cation exchanger membranes. Each pair of ion exchanger membranes forms a separate “cell”. In technical systems, these stacks consist of more than two hundred membrane pairs. If a direct electric current is applied to the electrodes, the anions migrate to the anode. The anions may simply pass the positively charged anion exchanger membranes but they are stopped at the respective negatively charged cation exchanger membrane. As the same process (obviously with opposite signs) is performed with the cations, the net effect of electrodialysis is a concentration of salts in the cells with odd numbers (anion exchanger membrane/cation exchanger membrane), while the cells with even numbers (cation exchanger membrane/anion exchanger membrane) suffer a depletion of salt. The solutions with increased salt concentrations are combined to form the concentrate, while the salt-depleted solutions form the diluate.

It is recommended to finally treat the diluate with a cation exchanger (“polisher”) and, particularly, to separate any sodium ions that had been introduced by dialysis.

The dialysed ultrafiltered milk permeate (“UF permeate”) such obtained is subsequently added to the skimmed milk concentrate in an amount such that the required, and desired lactose content of about 45 to about 60% by weight is obtained, based on the dried finished product.

### Drying

In the final process step, the product is dried. Preferably, spray-drying is applied, whereby the temperature at the inlet typically is about 180 to about 260° C., and about 80 to about 105° C. at the outlet. As a result, the fraction does not need any cooling before entering the tower. Temperatures of 60 to 70° C. are even preferred in this process, as this reduces the risk of denaturation of the proteins. Alternatively, the products may also be dehydrated by freeze drying.

Further additives such as, for example, lactoferrin, lecithins, vitamins or food emulsifiers and the like may be added to the product before but preferably after drying.

### INDUSTRIAL APPLICABILITY

A further subject matter of the invention relates to the use of both the milk protein concentrates of the invention and the products obtained according to the process of the invention for the production of foods for toddlers.

### EXAMPLES

### Comparison Example V1A

### Production of a UF Permeate

500 L of milk was pasteurised and subjected to ultrafiltration at 25° C. using a polymer membrane having a pore size of 10,000 Dalton. Separately, the retentate was further processed, and the permeate was further used for standardisation.

### Comparison Example V1B

### Production of a Protein Concentrate with a Typical Ash Content

1,000 L of skimmed milk with a dry matter content of 9% by weight was placed into an evaporator and was gently concentrated at about 70° C. to a dry matter content of 50% by weight. The permeate of example V1A was added to the concentrate in an amount such that a protein content of 34% by weight and a lactose content of 50% by weight was achieved, based on dry matter. Subsequently, the standardised milk concentrate was placed into a spray tower and was dried at 220° C. The resulting powder showed the following composition:

Dry matter content: 95.6% by weight
Protein content, based on dry matter: 34.1% by weight
Lactose content, based on dry matter: 51.3% by weight
Ash content, based on dry matter: 8.4% by weight

75 g of the powder were dissolved in 100 g of water at 20° C. and homogenised. The product showed a bitter taste with an astringent touch.

### Example 1A

### Production of a Dialysed UF Permeate

500 L of milk was pasteurised and subjected to ultrafiltration at 25° C. with a polymer membrane having a pore size 10,000 Dalton. Separately, the retentate was further processed. and the permeate was placed into an electrodialysis stack. In doing so, a lactose-rich and low-ash product was obtained, which was further used for standardisation.

### Example 1B

### Production of a Protein Concentrate with a Reduced Ash Content

1,000 L of skimmed milk with a dry matter content of 9% by weight was placed into an evaporator and was gently concentrated at about 70° C. to a dry matter content of 50% by weight. The diluate of example 1A was added to the concentrate in an amount such that a protein content of 34% by weight and a lactose content of 51% by weight was achieved, based on dry matter. Subsequently, the standardised milk concentrate was placed into a spray tower and was dried at 220° C. The resulting powder showed the following composition:

Dry matter content: 95.1% by weight
Protein content, based on dry matter: 34.3% by weight
Lactose content, based on dry matter: 51.8% by weight
Ash content, based on dry matter: 6.8% by weight

75 g of the powder were dissolved in 100 g of water at 20° C. and homogenised. The powder shows a flawless taste without any bitter or astringent touch.

1. A milk protein concentrate, obtained the steps of:
(i) separating raw milk, and obtaining a skimmed milk fraction having a dry matter content of about 5 to about 15% by weight, and particularly about 10% by weight;
(ii) concentrating the skimmed milk fraction of step (i) to a dry matter content of about 45 to about 60% by weight;
(iii) standardising the skimmed milk concentrate of step (ii) by adding a milk fraction; and
(iv) drying the standardised skimmed milk concentrate to a powder having a dry matter content of at least 95% by weight,
wherein a milk permeate is used for standardisation, which was previously subjected to electrodialysis.

2. The concentrate of claim 1, having a protein content of at least 34% by weight in the non-fat dry matter.

3. The concentrate of claim 2, having a lactose content of about 45 to about 60% by weight, based on dry matter.

4. The concentrate of claim 1, having an ash content of a maximum of 7.5% by weight.

5. A process for the production of skimmed milk protein, comprising the following steps:
(i) providing a skimmed milk with a dry matter content of about 5 to about 15% by weight, and particularly about 10% by weight;
(ii) concentrating the skimmed milk of step (a) to a dry matter content of about 45 to about 60% by weight;
(iii) standardising the skimmed milk concentrate of step (ii) with a milk fraction; and
(iv) drying the standardised skimmed milk concentrate of step (iii), obtaining a skimmed milk protein concentrate with a dry matter content of at least 95% by weight,
wherein a milk permeate is used for standardisation, which was previously subjected to electrodialysis.

6. The process of claim 5, wherein the skimmed milk is adjusted to a dry matter content of about 50% by weight in step (ii).

7. The process of claim 5, wherein a permeate is used as a milk fraction which is obtained by ultrafiltration of milk.

8. The process of claim 5, wherein an amount of milk permeate is added to the skimmed milk concentrate such that a lactose content of about 45 to about 60% by weight is obtained, based on dry matter.

9. The process of claim 5, wherein the standardised skimmed milk concentrate is spray-dried.

10. The process of claim 9, wherein spray-drying is performed at temperatures within the range of about 180 to about 260° C.

11. The process of claim 5, wherein further additives are added to the standardised skimmed milk concentrate before, during or after drying.

12. The process of claim 5, wherein a powder having a protein content of at least 34% by weight is obtained.

13. The process of claim 5, wherein a powder having a lactose content of about 48 to about 59% by weight is obtained.

14. The process of claim 5, wherein a powder having an ash content of a maximum of 7% by weight is obtained.

15. A process for the production of food for toddlers, comprising utilizing the milk protein concentrate of claim 1.
